(19) United States
(12) Patent Application Publication
(10) Pub. No.: US 2013/0105009 A1
(43) Pub. Date: May 2, 2013

(54) FLOW CONTROL VALVE

(71) Applicant: Aisan Kogyo Kabushiki Kaisha, Obu-shi (JP)

(72) Inventor: Hiroshi ODA, Obu-shi (JP)

(73) Assignee: AISAN KOGYO KABUSHIKI KAISHA, Obu-shi (JP)

(21) Appl. No.: 13/664,747

(22) Filed: Oct. 31, 2012

(30) Foreign Application Priority Data
Oct. 31, 2011 (JP) 2011-238481

(51) Int. Cl. F16K 15/00

(52) U.S. Cl. 137/517

(57) ABSTRACT

Disclosed is a flow control valve capable of preventing the seat portion from being interfered with when the valve body is operated. A PCV valve is equipped with a case, a valve body, and a spring. A measurement portion is formed by a measurement hole of a seat portion formed halfway through a gas path 50 and a measurement surface formed on the valve body. Through axial movement of the valve body, the path sectional area of the measurement portion is adjusted, whereby the flow rate of a fluid is controlled. Formed on the valve body are a plurality of guide ribs protruding radially and having sliding surfaces configured to be brought into sliding contact with the inner peripheral surface of the measurement hole. A maximum diameter surface portion of the measurement surface is formed in an outer diameter. This outer diameter is preferably smaller than the diameter of a circumferential surface. The circumferential surface preferably includes the sliding surfaces of the guide ribs.

### CROSS-REFERENCES TO RELATED APPLICATIONS

This application claims priority to Japanese Patent Application Serial Number 2011-238481, the contents of which are incorporated herein by reference.

### BACKGROUND OF THE INVENTION

1. Field of the Invention

The present application relates to a flow control valve for controlling the flow rate of a fluid.

2. Description of the Related Art

A positive crankcase ventilation (PCV) valve for controlling the flow rate of blow-by gas is used in a positive crankcase ventilation system of an internal combustion engine. It can be used, for example, in an automobile (See, for example, Japanese Patent Application Laid-Open No. 2007-120660).

A conventional PCV valve (See Japanese Patent Application Laid-Open No. 2007-120660) will be described. FIG. 10 is a sectional view of a PCV valve, and FIG. 11 is a sectional view taken along the arrow line XI-XI of FIG. 10. As shown in FIG. 10, a PCV valve 100 is equipped with a case 102, a valve body 104, and a spring 106. The case 102 has a gas path 108 in the form of a hollow cylinder extending in its axial direction (the horizontal direction as seen in FIG. 10). Blow-by gas is circulated through the gas path 108. The valve body 104 is provided inside the gas path 108 so as to be capable of moving back and forth in the axial direction. The spring 106 is provided between the case 102 and the valve body 104, and urges the valve body 104 in the retreating direction (to the right as seen in FIG. 10). At the central portion of the case 102, there is a concentrically formed seat portion 110 protruding radially inwards in a flange-like fashion. A hollow, cylinder-like hole within the seat portion 110 acts as a measurement hole 112. Further, a tapered portion of the measurement surface 114 is concentrically formed on the valve body 104. The measurement surface 114 includes the front end portion of a shaft-like portion 105 on the proximal side of the valve body 104 wherein it has a maximum diameter at measurement surface portion 114a. A measurement portion 116 is formed of the measurement hole 112 and the measurement surface 114.

The PCV valve 100 controls, i.e., measures, the flow rate of blow-by gas flowing through the gas path 108 by adjusting the sectional area of the measurement portion 116. The measurement portion 116 lies within the valve body 104. The valve body 104 has three guide ribs 118 protruding radially and having sliding surfaces 118a configured to be brought into sliding contact with an inner peripheral surface of the measurement hole 112 of the seat portion 110 (See FIG. 11). Further, formed at the rear end portion (the right end portion in FIG. 10) of the valve body 104 are three protrusions 120 (two of which are shown in FIG. 10) protruding radially and having sliding surfaces (not indicated by a reference numeral) configured to be brought into sliding contact with a path wall surface 109 on the upstream side of the gas path 108. Accordingly, as the valve body 104 operates, i.e., advances or retreats, the sliding surfaces 118a of the guide ribs 118 are brought into sliding contact with the inner peripheral surface of the measurement hole 112 of the seat portion 110. Furthermore, the sliding surfaces of the protrusions 120 are brought into sliding contact with the path wall surface 109 on the upstream side of the gas path 108. As a result, the valve body 104 is guided in the axial direction.

The valve body 104 has a measurement surface 114. The measurement surface 114 has a maximum diameter on the measurement surface portion 114a. The valve body 104 is part of the shaft-like portion. The circumferential surface of the guide ribs 118 has sliding surface 118. The outer peripheral surface of the shaft-like portion 105 and the circumferential surface of the guide ribs 115 are formed on the same diameter. When the valve body 104 is operated, in particular, there is a fear that the front end portion of the surface portion 114a could interfere with (contacting, abutting, etc.) the measurement hole 112 of the seat portion 110.

As shown in FIG. 11, sometimes an area lying between the guide ribs 118 lies on the bottom center of the seat portion. In this situation, the valve body 104 may be located off center and lie slightly downward with respect to the seat portion 110. This occurs partially due to the existence of a gap lying between the inner peripheral surface of the measurement hole 112 of the seat portion 110 and the sliding surfaces 118a of the guide ribs 118. This gap is required for securing the gas flow path. In FIG. 11, a point 110P corresponds to the axis of the seat portion 110. A point 104P corresponds to the axis of the valve body 104.

When the valve body 104 is located off center and lies slightly downward with respect to the seat portion 110, the front end portion (indicated by reference numeral 104a in FIG. 10) of the maximum diameter measurement surface portion 114a of the valve body 104 interferes with (i.e., contacts, abuts, etc.) the hole edge portion (indicated by reference numeral 110a in FIG. 10) of the measurement hole 112 of the seat portion 110. This interference typically occurs when the valve body 104 moves forward. When the seat portion 110 is interfered with during operation of the valve body 104, the portions (110a, 104a) of the seat portion 110 and/or the valve body 104 may suffer deformation. Accordingly, there has been a need for improved flow control valves.

### SUMMARY OF THE INVENTION

In one aspect of the present disclosure, a flow control valve is equipped with a case having a fluid path. A valve body may be provided within the fluid path so as to be capable of axially advancing and retreating. The flow control valve may have a spring urging the valve body in the retreating direction. A measurement portion may be formed using a measurement hole of a seat portion formed halfway through the fluid path and a tapered measurement surface formed on the valve body. The flow rate of the fluid may be controlled by adjusting the path sectional area of the measurement portion through axial movement of the valve body. The valve body may have a plurality of guide ribs protruding radially and sliding surfaces configured to be brought into sliding contact with the inner peripheral surface of the measurement hole. A maximum diameter measurement surface portion of the measurement surface is formed in an outer diameter. This outer diameter is smaller than the diameter of the circumferential surface. The circumferential surface includes the sliding surfaces of the guide ribs.

In accordance with this aspect, when the valve body advances or retreats, the sliding surfaces of the guide ribs of the valve body are brought into sliding contact with the inner peripheral surface of the measurement hole of the seat portion of the case. This results in the valve body being guided in the axial direction. Further, the maximum diameter measurement surface portion of the measurement surface is formed on an outer diameter. This diameter is preferably smaller than the diameter of the circumferential surface. The circumferential diameter includes the sliding surfaces of the guide ribs, so that even if the valve body is offset (deviated) downwardly in the gravitational direction with respect to the seat portion, it is still possible to secure a gap between the measurement hole and the maximum diameter measurement surface portion. The valve body may be offset (deviated) downwardly due to a slight gap necessary for the relative sliding of the inner peripheral surface of the measurement hole of the seat portion and the sliding surfaces of the guide ribs. As a result, it is possible to prevent the operation of the valve body from interfering with the seat portion. Furthermore it is possible to prevent deformation such as wear of the seat portion and/or the valve body. This further serves to prevent deterioration in the flow rate characteristics of the flow control valve.

### BRIEF DESCRIPTION OF THE DRAWINGS

FIG. 1 is a sectional view of a PCV valve according to a first embodiment;

FIG. 2 is a sectional view taken along the arrow line II-II of FIG. 1;

FIG. 3 is an enlarged view of portion III of FIG. 2;

FIG. 4 is a sectional view taken along the line IV-IV of FIG. 1;

FIG. 5 is a perspective view of a valve body;

FIG. 6 is a front view of the valve body;

FIG. 7 is a side view of the valve body;

FIG. 8 is a diagram schematically illustrating the system configuration of a positive crankcase ventilation system;

FIG. 9 is a side view of a valve body according to a second embodiment;

FIG. 10 is a sectional view of a conventional PCV valve; and

FIG. 11 is a sectional view taken along the arrow line XI-XI of FIG. 10.

### DETAILED DESCRIPTION OF THE INVENTION

Each of the additional features and teachings disclosed above and below may be utilized separately or in conjunction with other features and teachings to provide improved flow control valves. Representative examples of the present invention, which examples utilize many of these additional features and teachings both separately and in conjunction with one another, will now be described in detail with reference to the attached drawings. This detailed description is merely intended to teach a person of ordinary skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

In the following, a first embodiment of the present disclosure will be described with reference to the drawings. The present embodiment employs, by way of example, a PCV valve for use in a positive crankcase ventilation system of an internal combustion engine as the flow control valve. For the sake of convenience in illustration, an example of the positive crankcase ventilation system will be described before describing a PCV valve. FIG. 8 is a diagram schematically illustrating the system configuration of a positive crankcase ventilation system. As shown in FIG. 8, a positive crankcase ventilation system 10 is a system in which blow-by gas leaked into a crankcase 15 of a cylinder block 14 from the combustion chamber of an engine main body 13 of an engine 12, which is an internal combustion engine, is introduced into an intake manifold 20 to be burned in the combustion chamber.

The engine main body 13 is equipped with a cylinder block 14, an oil pan 15 fastened to the lower surface side of a crankcase 15, a cylinder head 17 fastened to the upper surface side of a cylinder block 14, and a cylinder head cover 18 fastened to the upper surface side of a cylinder head 17. The engine main body 13 provides drive force through the steps of intake, compression, explosion, and exhaust. As a result of the combustion within the combustion chamber (not shown) of the engine main body 13, blow-by gas is generated in the engine main body 13, i.e., in the crankcase 15, and in the cylinder head cover 18 which communicates with the interior of the crankcase 15. The interior of the cylinder head cover 18, the interior of the crankcase 15, etc. into which the blow-by gas flows correspond to the “interior of the engine main body” as referred to in this disclosure.

A fresh air introduction port 18a and a blow-by gas extraction port 18b are provided in the cylinder head cover 18. The fresh air introduction port 18a communicates with one end (downstream end) of a fresh air introduction path 30. The blow-by gas extraction port 18b communicates with one end (upstream end) of the blow-by gas path 36. The fresh air introduction port 18a and the blow-by gas extraction port 18b may be provided in the crankcase 15 instead of being provided in the cylinder head cover 18.

The cylinder head 17 communicates with one end (downstream end) of the intake manifold 20. The intake manifold 20 is equipped with a surge tank 21. The other end (upstream end) of the intake manifold 20 communicates with an air cleaner 25 via a throttle body 24 and an intake duct 23. The throttle body 24 is equipped with a throttle valve 24a. The throttle valve 24a is connected, for example, to an accelerator pedal (not shown), and is opened and closed depending on the amount of pedal depression. The air cleaner 25 serves to introduce air or so-called fresh air, and contains a filter element 26 configured to filter the fresh air. A series of intake path 27 for introducing air, i.e., fresh air, into the combustion chamber of the engine main body 13 is formed by the air cleaner 25, the intake duct 23, the throttle body 24, and the intake manifold 20. Regarding the intake path 27, the path portion on the upstream side of the throttle valve 24a is referred to as an upstream side intake path portion 27a, and the path portion on the downstream side of the throttle valve 24a is referred to as a downstream side intake path portion 27b.

A fresh air intake port 29 is formed in the intake duct 23. The fresh air intake port 29 communicates with the other end (upstream end) of the fresh air introduction path 30. The fresh air introduction path 30 is provided with a check valve 32. The check valve 32 permits flow of air or so-called fresh air from the upstream side intake path portion 27a into the crankcase 15 (See the arrow Y1 in FIG. 8), and prevents flow in the reverse direction or reverse flow (See the arrow Y3 in FIG. 8). A blow-by gas introduction port 34 is formed in the surge tank 21. The blow-by gas introduction port 34 communicates with the other end (downstream end) of the blow-by gas path 36. The check valve 32 may be omitted in certain embodiments.

Next, the operation of the positive crankcase ventilation system 10 will be described. When the engine 12 is under low or intermediate load, the throttle valve 24a is substantially closed. Thus, generated in the downstream side intake path portion 27b of the intake path 27 is a negative pressure compared to that generated in the upstream side intake portion 27a (i.e., a negative pressure increases toward the vacuum side). Accordingly, the blow-by gas in the engine main body 13 is introduced into the downstream side intake path portion 27b via the blow-by gas path 36 (See the arrow Y2 in FIG. 8). At this time, the flow rate of the blow-by gas flowing through the blow-by gas path 36 is controlled by a PCV valve 40 (described below).

As the blow-by gas is introduced into the downstream side intake path portion 27b from within the engine main body 13 via the blow-by gas path 36, the check valve 32 is opened. As a result, the fresh air in the upstream side intake path portion 27a of the intake path 27 is introduced into the engine main body 13 via the fresh air introduction path 30 (See the arrow Y1 in FIG. 8). And, the fresh air introduced into the engine main body 13 is introduced into the downstream side intake path portion 27b via the blow-by gas path 36 together with the blow-by gas (See the arrow Y2 in FIG. 8). In the manner as described above, the interior of the engine main body 13 is cleaned.

When the engine 12 is under a high load, the opening amount of the throttle valve 24a is large. Therefore, the pressure in the downstream side intake path portion 27b of the intake path 27 simulates atmospheric pressure. Accordingly, the blow-by gas in the engine main body 13 is not easily introduced into the downstream side intake path portion 27b, and the pressure in the engine main body 13 also simulates atmospheric pressure. As a result, the flow rate of the fresh air introduced into the engine main body 13 from the upstream side intake path portion 27a via the fresh air introduction path 30 decreases. Further, as a result of the closing of the check valve 32, reverse flow of the blow-by gas to the fresh air introduction path 30 from within the engine main body 13 (See the arrow Y3 in FIG. 8) is prevented.

Provided in the blow-by gas path 36 may be a PCV valve 40, which is used as a flow control valve for controlling the flow rate of the blow-by gas. The PCV valve 40 controls or measures the flow rate of the blow-by gas in accordance with the difference between the upstream side pressure and the downstream side pressure of the blow-by gas. In this way it is possible to cause the blow-by gas to flow at a flow rate that conforms with the amount of blow-by gas generated in the engine.

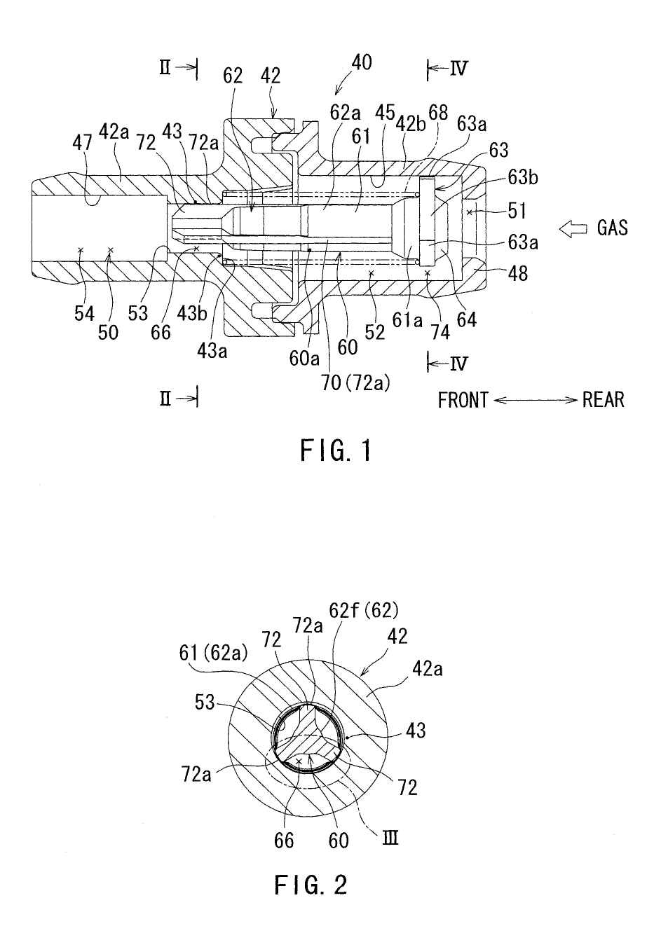

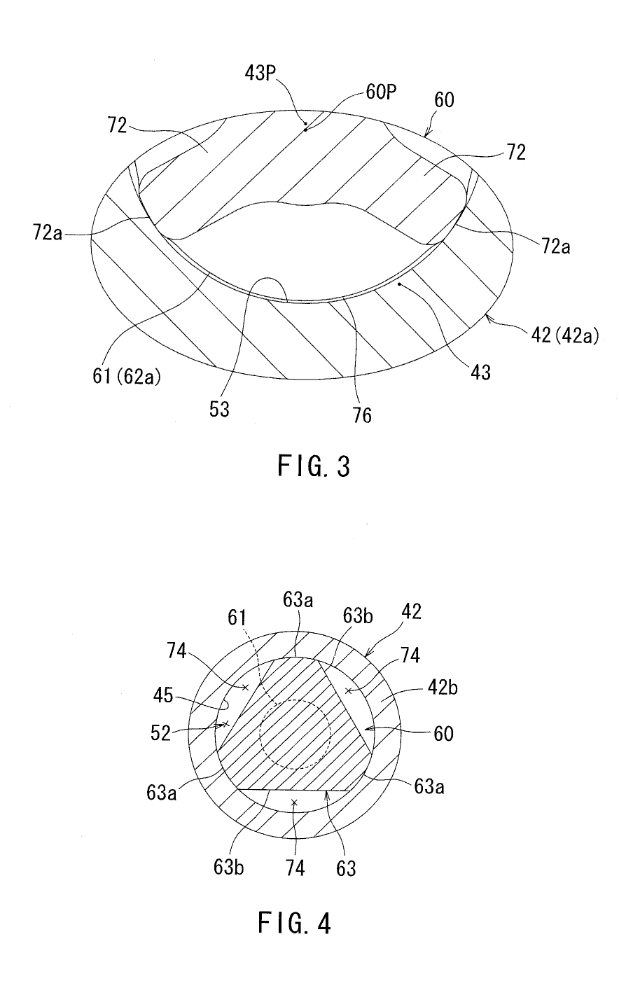

Next, the PCV valve 40 will be described. FIG. 1 is a sectional view of the PCV valve, FIG. 2 is a sectional view taken along the arrow line II-II of FIG. 1, FIG. 3 is an enlarged view of portion III of FIG. 2, and FIG. 4 is a sectional view taken along the arrow line IV-IV of FIG. 1. For the sake of convenience in illustration, the left-hand side in FIG. 1 will be referred to as the front side, and the right-hand side therein will be referred to as the rear side. As shown in FIG. 1, a case 42 of the PCV valve 40 is formed, for example, of resin, as a hollow cylinder. The hollow portion of the interior of the case 42 constitutes a gas path 50 extending in the axial direction (the horizontal direction in FIG. 1). The rear end portion of the case 42 (the right end portion of FIG. 1) is connected to the upstream side path portion of the blow-by gas path 36 (See FIG. 8). The front end portion (the left-hand end portion in FIG. 1) of the case 42 is connected to the downstream side path portion of the blow-by gas path 36. The rear end portion of the case 42 may be connected to the blow-by gas extraction port 18b of the cylinder head cover 18. Blow-by gas, which is a fluid, flows through the gas path 50. The gas path 50 corresponds to the “fluid path” as referred to in the this disclosure.

The case 42 is axially (longitudinally) divided into two portions, i.e. front and rear case halves 42a and 42b, which are bonded to each other to form the case 42. At the central portion of the front side case half 42a, there is concentrically formed a seat portion 43 protruding radially inwards in a flange-like fashion. A stepped surface 43a is formed on the rear side surface of the seat portion 43. Further, formed in the rear side case half 42b, i.e., on the gas inflow side of the gas path 50 (the right-hand side in FIG. 1), is an upstream side path wall surface 45 in the form of a hollow cylinder. The upstream side path wall surface 45 constitutes an upstream side path portion 52. Further, on the front side of the seat portion 43 of the front side case half 42a, that is, on the gas outflow side (the left-hand side in FIG. 1), there is formed a downstream side wall surface 47 in the form of a hollow cylinder. The interior of the downstream side path wall surface 47 constitutes a downstream side path portion 54. A hole in the form of a hollow cylinder in the seat portion 43 constitutes a measurement hole 53 for allowing communication between the upstream side path portion 52 and the downstream side path portion 54. Further, at the rear end portion of the rear side case half 42b, there is concentrically formed a throttle wall portion 48 protruding radially inwards in a flange-like fashion beyond the upstream side path wall surface 45. The circular hole portion in the throttle wall portion 48 constitutes an inlet 51 for the gas path 50 (more specifically, the upstream side path portion 52).

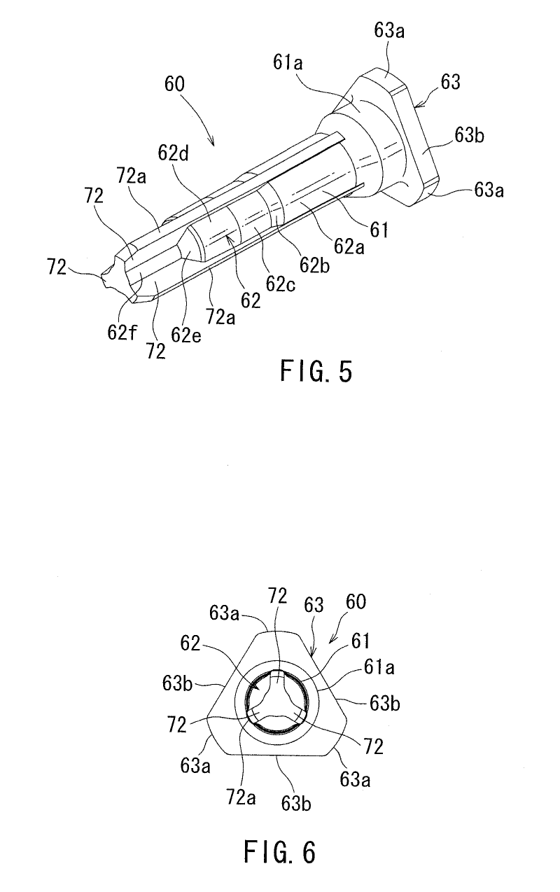

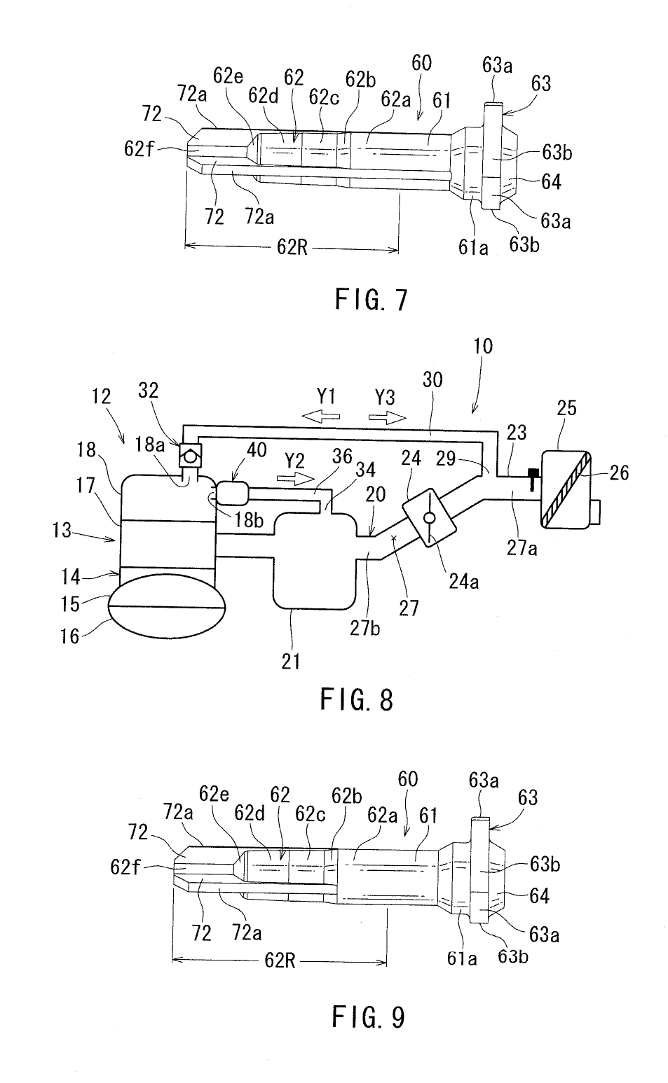

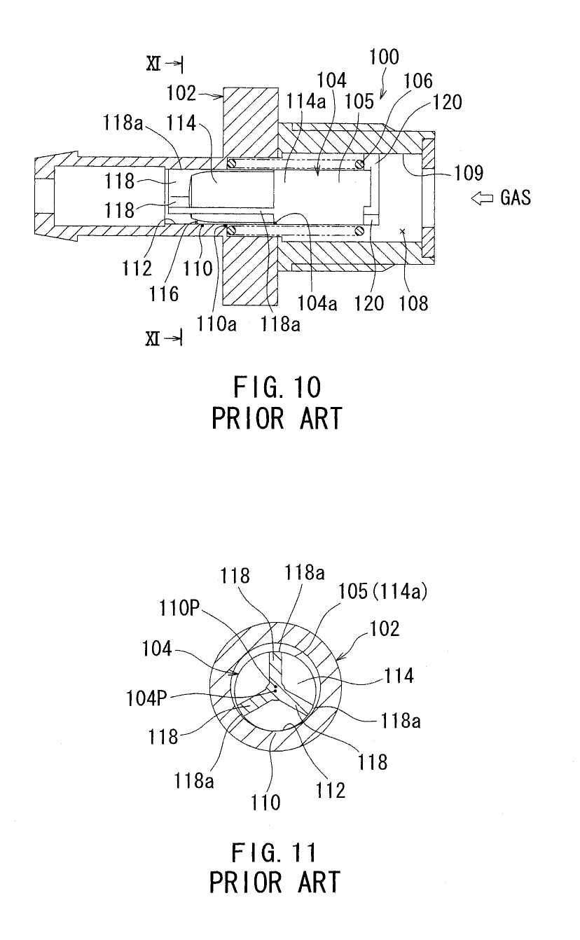

Inside the case 42, i.e., inside the gas path 50, there is arranged a valve body 60 which is capable of advancing and retreating in the axial direction (the horizontal direction in FIG. 1). FIG. 5 is a perspective view of the valve body, FIG. 6 is a front view of the same, and FIG. 7 is a side view of the same. As shown in FIGS. 5 through 7, the valve body 60 is formed, for example, of resin, so as to exhibit a valve main body portion in the form of a round-shaft-like portion. A tapered measurement surface 62 is concentrically formed on the outer peripheral surface of the front half portion (the left-hand half in FIG. 7) of the valve main body portion. The measurement surface 62 includes the front end portion of the shaft-like portion 61 of the rear half of the valve main body portion as a maximum diameter measurement surface portion 62a. The measurement surface 62 is formed as a stepped tapered surface having six steps in total, i.e., measurement surface portions 62a through 62f as from the maximum diameter measurement surface portion 62a toward the small diameter side (See FIG. 5). The tapering angles of the measurement surface portions 62a through 62f are set as appropriate; one or two measurement surface portions of the measurement surface portions 62b through 62f except for the maximum diameter measurement surface portion 62a may be formed as straight surfaces. The number of measurement surface portions 62a through 62f may be changed as appropriate.

As shown in FIG. 1, the front end portion (distal end portion) of the valve body 60 is inserted into the measurement hole 53 of the seat portion 43 from the upstream side path portion 52 side of the gas path 50. A measurement portion 66 is formed by the measurement hole 53 (more specifically, the inner peripheral surface) of the seat portion 43 and the measurement surface 62 of the valve body 60. Accordingly, as the valve body 60 retreats (i.e., as it moves to the right in FIG. 1), the effective opening area of the measurement portion 66, i.e., the path sectional area thereof, increases. Conversely, as the valve body 60 advances (i.e., as it moves to the left as seen in FIG. 1), the path sectional area of the measurement portion 66 is reduced. The measurement surface 62 of the valve body 60 corresponds to the interior of the measurement hole 53 of the seat portion 43 within the operational range between the rearmost position and the foremost position of the valve body 60. In FIG. 7, a range 62R indicates the range of the measurement surface 62 of the valve body 60 corresponding to the interior of the measurement hole 53 of the seat portion 43 in the operational range of the valve body 60. Further, a large diameter shaft portion 61a is fanned at the rear end portion (the right end portion in FIG. 7) of the shaft-like portion 61 of the valve body 60. At the rear end portion of the large diameter shaft portion 61a, there is concentrically formed a flange portion 63 protruding radially outwards. The valve body 60 corresponds to the “valve body” as referred to in this disclosure.

As shown in FIG. 1, between the case 42 and the valve body 60, there is provided a spring 68 consisting of a compression coil spring. The spring 68 is fit-engaged with the shaft-like portion of the valve body 60. The front end portion (more specifically, the end turn portion) of the spring 68 is locked to the stepped surface 43a of the seat portion 43. The rear end portion (more specifically the end turn portion) of the spring 68 is locked to the front end surface of the flange portion 63 while fit-engaged with the large diameter shaft portion 61a of the shaft-like portion 61. The spring 68 constantly urges the valve body 60 in the retreating direction (to the right in FIG. 1), i.e., in the direction in which the path sectional area of the measurement portion 66 increases. Further, at the rear end surface of the flange portion 63, there is concentrically formed a truncated-cone-shaped enlarged portion 64. When the valve body 60 is at the rearmost position due to backfire or the like, the tapered surface of the enlarged portion 64 abuts the port edge portion of the inlet 51 of the case 42, whereby the inlet 51 is closed.

As shown in FIGS. 5 through 7, there radially protrude, for example, three, guide ribs 72 from the shaft-like portion of the valve body 60. The guide ribs 72 are arranged at equal intervals in the peripheral direction of the valve body 60, i.e., at an interval of 120°. The guide ribs 72 extend linearly in the axial direction of the valve body 60. Further, the guide ribs 72 are formed to extend over the entire length of the shaft-like portion including the measurement surface 62 of the valve body 60. The remaining shaft-like portion, (excluding the large diameter shaft portion 61a and the flange portion 63 of the valve body 60), corresponds to the “shaft-like portion inclusive of the measurement surface.”

As a result of the setting of the guide ribs 72, the measurement surface 62 and the measurement portion 66 are each divided into three portions in the peripheral direction of the valve body 60. The end surfaces on the outer peripheral side of the guide ribs 72 constitute sliding surfaces 72a. The sliding surfaces 72a are formed on a circumferential surface whose center is at the axis of the valve body 60, and can be brought into sliding contact with the inner peripheral surface of the measurement hole 53 of the seat portion 43 (See FIGS. 1 and 2). A maximum diameter measurement surface portion 62a of the measurement surface 62, (i.e., the shaft-like portion 61), is formed in an outer diameter. The outer diameter is preferably smaller than the diameter of the circumferential surface. The circumferential surface preferably encompasses the sliding surfaces 72a of the guide ribs 72. That is, the sliding surfaces 72a of the guide ribs 72 are formed in a circumferential surface. Compared to the outer diameter of the maximum diameter measurement surface portion 62a of the measurement surface 62, this diameter of the circumferential surface is larger.

As shown in FIG. 6, on the outer peripheral surface of the flange portion 63, there are formed, for example, three sliding surfaces 63a and three cutout surfaces 63b. The sliding surfaces 63a can be brought into sliding contact with the upstream side path wall surface 45 (See FIGS. 1 and 4). Thus, the flange portion 63 constitutes a guide flange (indicated by the same reference numeral as the flange portion) having the sliding surfaces 63a. The openings defined between the cutout surfaces 63b and the upstream side path wall surface 45 constitute communicating portions 74 through which blow-by gas is circulated.

Next, the operation of the PCV valve 40 will be described. When the downstream side path portion 54 of the gas path 50 in the case 42 attains a pressure (negative pressure) lower than that in the upstream side path portion 52 thereof, blow-by gas flows into the upstream side path portion 52 from the inlet 51, and then flow out via the communicating portions 74, the measurement portion 66, and the downstream side path portion 54. At this time, the valve body 60 advances or retreats (moves in the axial direction) in accordance with the difference between the upstream side pressure of the upstream side path portion 52 and the downstream side pressure of the downstream side path portion 54 (inclusive of the urging force of the spring 68). As a result, the flow rate of the blow-by gas flowing through the gas path 50 is controlled. More specifically, when the upstream side pressure is higher than the downstream side pressure, and the difference between the upstream side pressure and the downstream side pressure is large, the valve body 60 advances against the urging force of the spring 68, and the path sectional area of the measurement portion 66 is reduced, so that the flow rate of the blow-by gas is reduced. When the difference between the upstream side pressure and the downstream side pressure is reduced, the valve body 60 is caused to retreat by the urging force of the spring 68, and the path sectional area of the measurement portion 66 increases, so that the flow rate of the blow-by gas increases. In this way, the flow rate of the blow-by gas flowing through the gas path 50 is controlled through an increase and reduction in the path sectional area of the measurement portion 66.

When the valve body 60 operates, i.e., advances or retreats, the sliding surfaces 72a of the guide ribs 72 are brought into sliding contact with the inner peripheral surface of the measurement hole 53 of the seat portion 43 of the case 42. Meanwhile the sliding surfaces 63a of the guide flange 63 are brought into sliding contact with the upstream side path wall surface 45 of the gas path 50 (See FIGS. 1, 2, and 4). As a result, the valve body 60 is guided in the axial direction.

In the PCV valve 40 described above, when the valve body 60 advances or retreats, the sliding surfaces 72a of the guide ribs 72 of the valve body 60 are brought into sliding contact with the inner peripheral surface of the measurement hole 53 of the seat portion 43 of the case 42. In this way, the valve body 60 is guided in the axial direction. As a result, it is possible to prevent radial run-out of the valve body 60, making it possible to achieve an improvement in terms of the operational stability of the valve body 60.

Further, the maximum diameter measurement surface portion 62a of the measurement surface 62 of the valve body 60 is formed in an outer diameter smaller than the diameter of the circumferential surface including the sliding surfaces 72a of the guide ribs 72. Accordingly, even if, as shown in FIG. 3, the valve body 60 is offset (deviated) downwardly in the gravitational direction with respect to the seat portion 43, it is possible to secure a gap 76 between the measurement hole 53 and the maximum diameter measurement surface portion 62a. In FIG. 3, reference numeral 43P represents the axis of the seat portion 43. Further, point 60P represents the axis of the valve body 60.

It is possible to prevent the front end portion (indicated by reference numeral 60a in FIG. 1) of the maximum diameter measurement surface portion 62a of the valve body 60 from interfering with the hole edge portion (indicated by reference numeral 43b in FIG. 1) during advancement of the valve body 60. By extension, it is possible to prevent deformation such as wear of the portion concerned (43b, 60a) of the seat portion 43 and/or the valve body 60, making it possible to prevent deterioration in the flow rate characteristics of the PCV valve 40.

Further, since the guide ribs 72 are formed to extend over the entire length of the shaft-like portion (which includes the measurement surface 62 of the valve body 60), it is possible to achieve an improvement in terms of releasability during resin mold manufacture of the valve body 60.

Further, the rear end portion of the valve body 60 is supported through sliding contact of the sliding surfaces 63a of the guide flange 63 with the upstream side path wall surface 45 of the gas path 50, so that it is possible to prevent radial run-out of the rear end portion of the valve body 60.

Further, the PCV valve is one to be used in the positive crankcase ventilation system 10 (See FIG. 8) of the engine 12. Accordingly, it is possible to provide a PCV valve 40 capable of preventing interference with the seat portion 43 at the time of operation of the valve body 60.

A second embodiment will be described. The present embodiment is one obtained through a change in the valve body 60 of the first embodiment, so the following description will center on the changed portion, and a redundant description will be left out. FIG. 9 is a side view of a valve body. As shown in FIG. 9, in the present embodiment, the portions of the guide ribs 72 (See FIG. 7) of the valve body 60 of the first embodiment corresponding to the shaft-like portion 61 included in the maximum diameter measurement surface portion 62a are omitted. However, when the valve body 60 advances or retreats, the state is maintained in which the sliding surfaces 72a of the guide ribs 72 are in sliding contact with the inner peripheral surface of the measurement hole 53 of the seat portion 43. In particular, when the valve body 60 is at the foremost position, the rear end portions of the sliding surfaces 72a of the guide ribs 72 are brought into sliding contact with the front end portion of the inner peripheral surface of the measurement hole 53 of the seat portion 43. When the valve body 60 is at the foremost position and/or the rearmost position, it is only necessary for a part of the sliding surfaces 72a of the guide ribs 72 to be brought into sliding contact with a part of the inner peripheral surface of the measurement hole 53 of the seat portion 43, and thus the length of the guide ribs 72 may be changed as needed.

The above-described embodiments of the present disclosure should not be construed restrictively; they allow modification without departing from the scope of the present disclosure. For example, the present disclosure is applicable not only to the PCV valve 40 but also to any other flow control valve configured to control the flow rate of a fluid other than blow-by gas. The material of the case 42 and/or the valve body 60 is not restricted to resin; it may also be metal. Further, the guide flange 63 may be formed as a flange portion with the sliding surfaces 63a omitted. Further, apart from being formed by cutout surfaces, the communicating portions 74 of the guide flange 74 may also be formed by a through-hole extending through the guide flange 63.

1. A flow control valve comprising:
a case having a fluid path;
a valve body provided within the fluid path which is capable of axially advancing and retreating;
a spring urging the valve body in the retreating direction;
wherein a measurement portion is formed using a measurement hole of a seat portion formed halfway through the fluid path and a tapered measurement surface formed on the valve body, wherein the flow rate of the fluid is controlled by adjusting a path sectional area of the measurement portion through axial movement of the valve body, wherein the valve body has a plurality of guide ribs protruding radially and having sliding surfaces configured to be brought into sliding contact with an inner peripheral surface of the measurement hole, and wherein a maximum diameter measurement surface portion of the measurement surface is formed in an outer diameter, the outer diameter is smaller than the diameter of the circumferential surface, the circumferential surface which includes the sliding surfaces of the guide ribs.

2. The flow control valve according to claim 1, wherein the guide ribs are formed so as to extend over the entire length of the shaft-like portion as well as the measurement surface of the valve body.

3. The flow control valve according to claim 1, wherein the valve body has a guide flange having a sliding surface configured to be brought into sliding contact with a path wall surface on an upstream side of the measurement hole of the fluid path.

4. A flow control valve comprising:
a case having a fluid path with a measurement hole; and
a valve body provided within the fluid path so as to be capable of axially advancing and retreating therein and having a measurement surface in a tapered-shape and a plurality of guide ribs, the guide ribs protruding outwardly in a radial direction and having sliding surfaces configured to be brought into sliding contact with a peripheral surface of the measurement hole, the valve body having an outer circumference including the sliding surfaces such that the diameter of the outer circumference is larger than a maximum diameter of the measurement surface.

5. The flow control valve according to claim 4, further comprising a spring urging the valve body in the retreating direction.

6. The flow control valve according to claim 4, wherein the valve body has a guide flange to be configured to slidably contact an inner circumferential surface of the fluid path on an upstream side of the measurement hole.

7. The flow control valve according to claim 4, wherein the guide ribs extends over the entire length of the measurement surface.

8. The flow control valve according to claim 4, wherein the measurement surface is formed in a stepped tapered-shape.

9. The flow control valve according to claim 4, wherein the case has a seat portion protruding radially inward in a flange-like fashion in the fluid path and defining the measurement hole.

10. The flow control valve according to claim 4, wherein the valve body has at least three guide ribs.
